(19) United States
(12) Patent Application Publication
(10) Pub. No.: US 2004/0034707 A1
(43) Pub. Date: Feb. 19, 2004

(54) System and user interface supporting multiple different concurrent application interoperability methods

(76) Inventor: Barry Lynn Royer, Blue Bell, PA (US)

Correspondence Address: Alexander J. Burke, Intellectual Property Department, 170 Wood Avenue Soutn, 5th Floor, Iselin, NJ, 08830, US

(21) Appl. No.: 10/458,170

(22) Filed: Jun. 10, 2003

Related U.S. Application Data
(60) Provisional application No. 60/387,651, filed on Jun. 11, 2002.

(51) Int. Cl. G06F 15/16

(52) U.S. Cl. 709/227

(57) ABSTRACT

A system supports concurrent operation of multiple network compatible applications using corresponding multiple different operation interfaces. The system includes a data processor, a first interface processor, and a second interface processor. The data processor formats context data received from a first application to be compatible with an interface data format of a second application and formats the received context data to be compatible with an interface data format of a third application in response to examination of an indicator identifying a network connection to the third application. The first interface processor communicates formatted and compatible context data to the second application. The second interface processor communicates formatted and compatible context data to the third application.

### CROSS-REFERENCE TO RELATED APPLICATIONS

The present application is a non-provisional application of provisional application having Ser. No. 60/387,651 filed by Barry Royer on Jun. 11, 2002.

### FIELD OF THE INVENTION

The present invention generally relates to information systems. More particularly, the present invention relates to a system and a user interface for supporting multiple different concurrent application interoperability methods.

### BACKGROUND OF THE INVENTION

The management of information for medical purposes for use by physicians, hospital staff, and other workers in the health care field poses a number of challenges. The information required by a physician, to optimize health care, is both varied in nature and in the sources from which it is derived. A physician may typically need to have access to patient medical records, diagnostic images, diagnostic and dietary information systems, an appointment schedule, patient test results, medical literature, a prescription and drug interaction management system, insurance and billing information as well as a staff management system, for example. Access to such information and related services necessitate the use of a system including a communication platform supporting Internet operation and possibly local intra-net operation. Further, it is desirable that such a system for providing access to such an array of comprehensive information sources and related services should also provide a user interface that is suitable for use by a layman in the field and should not require extensive operator training.

There are a number of difficulties in providing such a comprehensive system. Specifically, it is desirable that such a system should support multiple different concurrent Internet or other network based applications with the capability of conveying information between individual applications. These difficulties are compounded by the fact different application interoperability methods are available and further, individual applications may employ a unique data format or other operational feature limiting concurrent operation and interoperability. Accordingly, there is a need for a system and a user interface for supporting multiple different concurrent application interoperability methods that addresses these difficulties and derivative problems.

### SUMMARY OF THE INVENTION

A system supports concurrent operation of multiple network compatible applications using corresponding multiple different operation interfaces. The system includes a data processor, a first interface processor, and a second interface processor. The data processor formats context data received from a first application to be compatible with an interface data format of a second application and formats the received context data to be compatible with an interface data format of a third application in response to examination of an indicator identifying a network connection to the third application. The first interface processor communicates formatted and compatible context data to the second application. The second interface processor communicates formatted and compatible context data to the third application.

These and other aspects of the present invention are further described with reference to the following detailed description and the accompanying figures, wherein the same reference numbers are assigned to the same features or elements illustrated in different figures. Note that the figures may not be drawn to scale. Further, there may be other embodiments of the present invention explicitly or implicitly described in the specification that are not specifically illustrated in the figures and visa versa.

### BRIEF DESCRIPTION OF THE DRAWINGS

FIG. 1 illustrates a web browser window including multiple links to a plurality of medical related applications, in accordance with a preferred embodiment of the present invention.

FIG. 2 illustrates a system command flow diagram showing system protocol operation involving a managing application (e.g., Global Session Manager (GSM)), two applications, and a web browser, in accordance with a preferred embodiment of the present invention.

FIG. 3 illustrates command interaction between multiple concurrently operating applications, a managing application, and a CCOW Interface Manager, in accordance with a preferred embodiment of the present invention.

FIG. 4 illustrates a system hierarchical protocol layer diagram including an interoperability protocol, in accordance with a preferred embodiment of the present invention.

FIG. 5 illustrates a system command flow diagram showing system protocol operation involving the web browser, a child application, a parent application, a managing application (e.g., GSM), and a CCOW context manager, in accordance with a preferred embodiment of the present invention.

### DETAILED DESCRIPTION OF THE PREFERRED EMBODIMENTS

A system and associated protocol enables Internet compatible applications comprising any grouping of software to be integrated into a workflow capable of supporting a browser. Workflow, as used in this document, refers to a task sequence typically involving initiation, intermediate command operation, and termination of Internet compatible applications via a displayed user interface occurring between a user logon and a user logoff command. The system involves a centralized session manager and protocol for passing URL data between applications and other functions. These include providing services to coordinate user inactivity timeouts and provide common, essential session properties for facilitating concurrent application operation for providing access to an array of comprehensive (medical and other) information sources and related services. Internet compatible applications employing this system may be dynamically reorganized to implement different workflows or task sequences involving different operational constraints and limitations. The system advantageously facilitates reuse and interoperability of web based applications in multiple different sequences and concurrent operation configurations.

The system addresses a variety of problems involved in supporting concurrent operation of Internet compatible applications for accessing multiple information sources and related services for medical and other purposes. As such, the system addresses the problems involved in maintaining concurrent operation of applications in a framework providing a common web browser-like user interface. The system specifically addresses problems involved in managing different inactivity timeout periods and in facilitating user initiation (e.g., logon), operation and termination (e.g., logoff) of multiple Internet applications, and in securely passing URL, patient (and user) identification and other information between applications. A managing application is employed to coordinate user operation sessions. Specifically the managing application coordinates inactivity timeout operation, and maintains and conveys properties between concurrent applications in order to create a smooth user operation session. For this purpose, the managing application also coordinates the use of a single logon screen common to multiple concurrent applications.

The principles of the invention may be applied to any system involving concurrent operation of different software applications. Further, although the disclosed system is described in the context of communicating and processing web page data and associated URLs (Universal Resource Locators), this is exemplary. The system may process any form of data that may be communicated over a network, including via Internet Protocol (IP) or HyperText Transmission Protocol (HTTP) from an Internet source, and includes any form of packet-type data including streamed video or audio data, telephone messages, computer programs, Emails or other communications, for example.

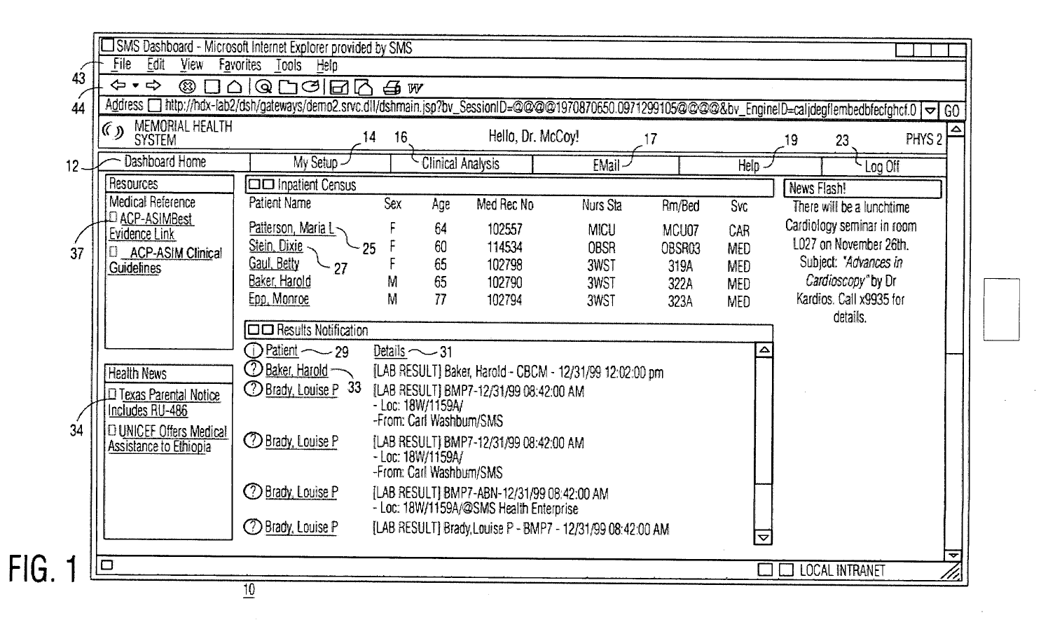

FIG. 1 shows a web browser composite window 10 providing a user interface display including multiple links to a plurality of medically related applications via user entry of identification information and/or commands. The web browser also provides user identification information to an application for validation. The web browser provides typical command toolbars 43 and 44 as well as an application initiation bar (items 12-23). The web browser interface permits a user to initiate multiple concurrent applications including, for example, an application providing an inpatient census window (e.g. for patients 25 and 27) together with a laboratory test results application providing a results notification window including displayed items 29, 31, and 33. Other concurrent applications permit access to health care information and resources such as via reference link 37 and news item link 34.

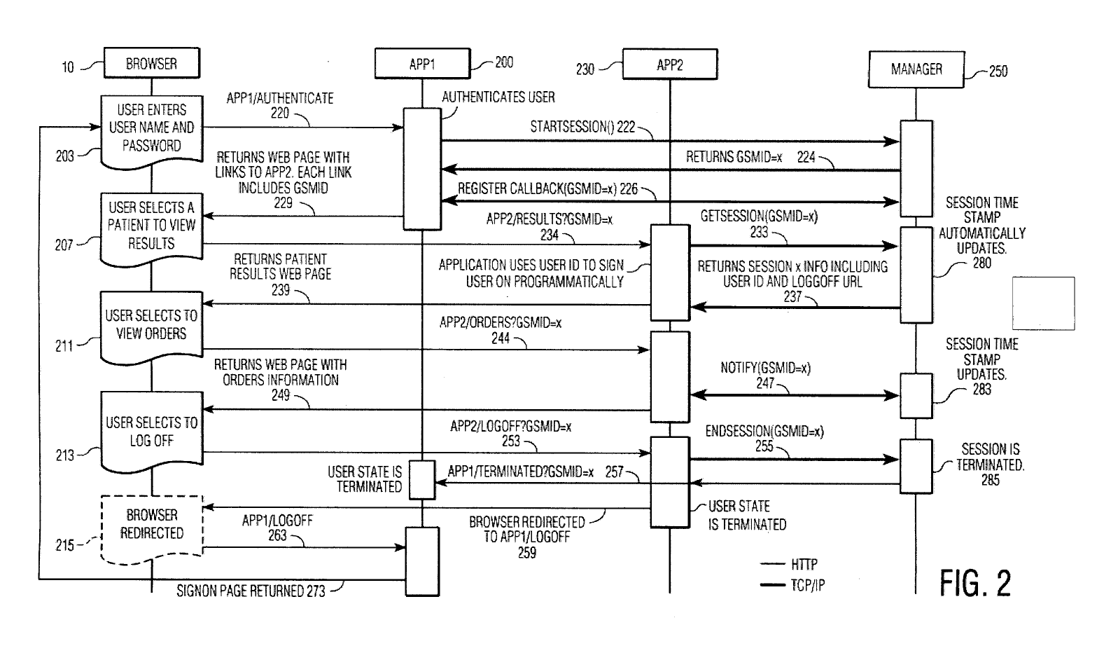

FIG. 2 is a system command flow diagram showing system protocol operation involving a managing application 250 (e.g., Global Session Manager (GSM)), two applications 200 (APP1) and 230 (APP2), and a web browser 10 (e.g. as described in connection with FIG. 1). The system protocol employed by the manager 250 supports coherent harmonized and concurrent operation of multiple applications (e.g., applications 200 and 230) in implementing a task sequence or workflow. The manager 250 is advantageously used by the applications 200 and 230 to reference global data that is essential to a workflow. Such global data includes, for example, user identification information, a shared key used for the encryption of URL data, and a common URL to be used for handling a logoff and logon function. The system protocol involves applications 200 and 230 intermittently notifying manager 250 of activity to prevent an inactivity timeout while a user is active in another concurrent application.

Manager 250 employs a system protocol for passing session context information to applications 200 and 230 via URL query or form data. The session context information comprises a session identifier, a hash value, and application specific data. The session identifier is used by applications 200 and 230 to identify a user initiated session in communicating with the manager 250. The hash value is used by applications 200 and 230 to validate that a received URL has not been corrupted, intentionally or otherwise. The application data portion of the session context information may or may not be encrypted, as determined by the application communicating the URL. The application specific data is tailored to meet the intended function of a target application. The protocol employed by the manager 250 supports applications that use the generated session context information and do not alter it. In alternative embodiments, applications 200 and 230 may employ internal managers using other protocols to support a global context concept, either as an alternative to the manager 250, or in addition to the manager 250. Such other protocols comprise, for example, HL7 (Health Level Seven) protocol or CCOW (Clinical Context Object Workgroup, e.g., V1.2 Ratified May 2000) protocol. The described system supports use of alternative protocols as well as the communication of data between applications, other than just session context information.

The manager 250 maintains security by operating in a secure environment that prevents unauthorized access to the manager application itself. Security is also provided by ensuring applications 200 and 230 (that communicate with manager 250) also operate in a secure environment. Manager 250 also maintains security by detecting and ignoring received URLs that have been intentionally or otherwise corrupted, and by preventing replay and display of received URLs.

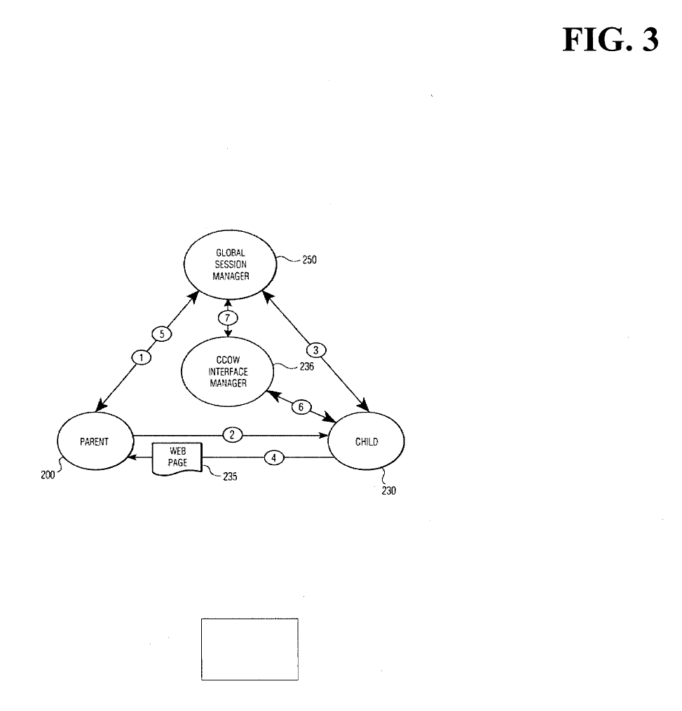

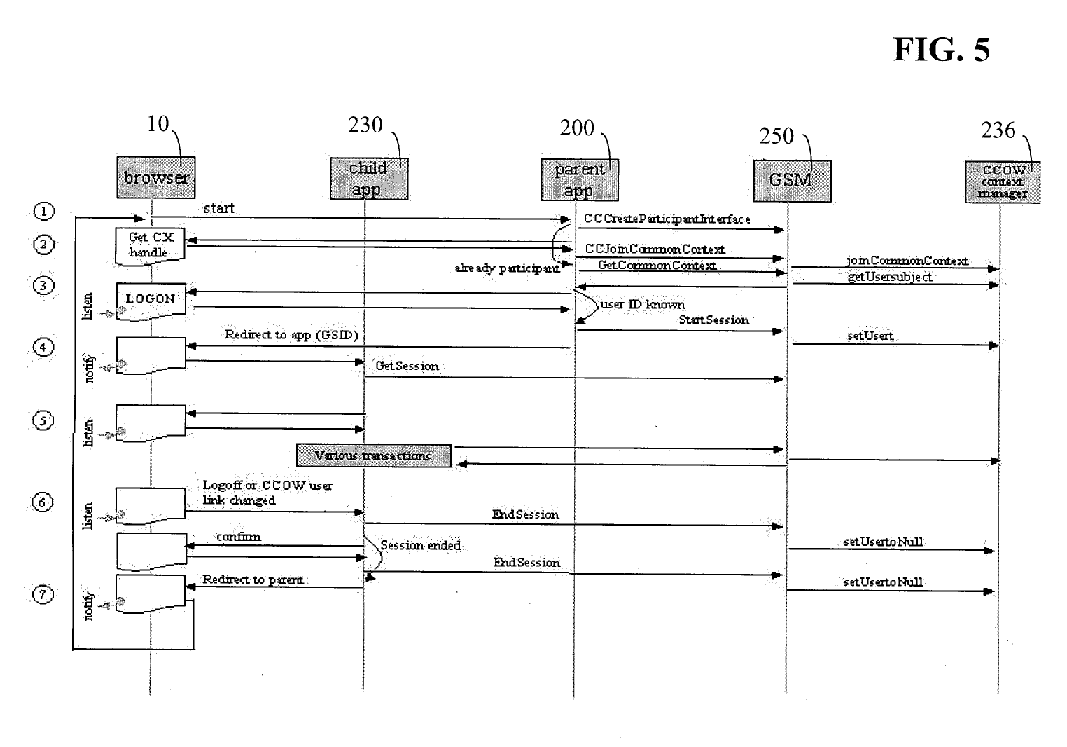

FIG. 3 shows command interaction between concurrently operating applications 200 and 230, a web browser 235, a CCOW interface manager 236, and the manager 250 using a system interoperability protocol, in accordance with the preferred embodiment of the present invention. The CCOW interface manager 236, as shown in FIG. 3, is also know herein as a CCOW context manager, as shown in FIG. 5.

In an exemplary user operation session, parent application 200 starts a session and notifies the manager 250 of activity (1). Subsequently, parent application 200 references a child application 230 (2). A child application typically provides web pages to other applications. Specifically, the child application 230 notifies the manager 250 of activity (3) and returns a web page 235 to the parent application 200 (4). Eventually, the parent application 200 terminates the session via a command to the manager 250 (5). If the child application 230 is a CCOW compatible application, the manager 250 forwards transformed command data to the CCOW interface manager 236 (7), and returns responses to the child application 230 (6). A CCOW compatible child application 230 may alternatively sends commands directly to the CCOW interface manager 236. The application that establishes a session with the manager 250 is defined to be the parent application. Additional applications that participate in that session are referred to as child applications. The collections of the parent and child applications together are defined to be the participants. The manager 250 provides centralized services to coordinate the parent and child applications. A parent application creates a session after the user is authenticated and before a child application is referenced. A parent application may delay establishing a session until a specific event, e.g., until the parent downloads (to a browser) a web page containing links to the child applications. Typically, a session is ended when the user signs off or when the user times out due to inactivity.

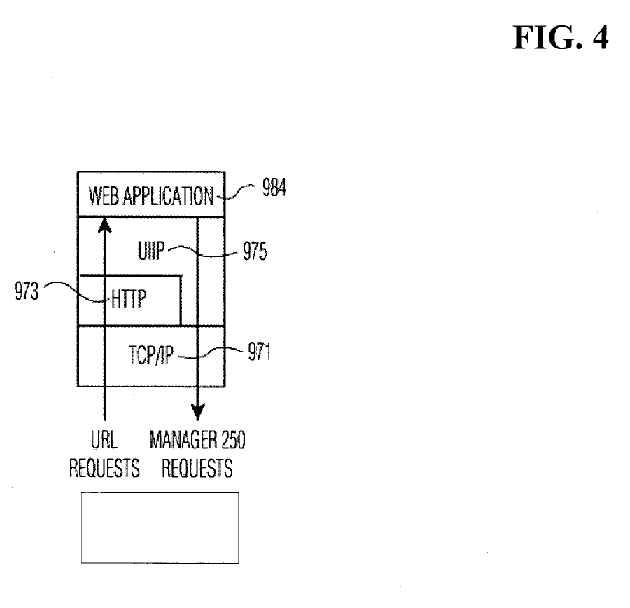

FIG. 4 is a system protocol diagram indicating the hierarchical organization of communication protocol layers used by applications 200 and 230 for communication with the browser 10 and the manager 250 (shown in FIG. 2). The applications 200 and 230 together with the browser 10 and the manager 250 provide access to medical information and related services in a system including a communication platform supporting Internet operation and local intranet operation. The system may also involve other networks including Local Area Networks (LANs), Wide Area Networks (WANs), and other dedicated hospital networks or other medical (or other) systems and communication networks.

An application (e.g., applications 200 and 230) residing in web application layer 984 communicates with the manager 250 using a User Interface Interoperability Protocol (UIIP) data format 975 comprising command data structures presented in Tables 1-17. The UIIP command and response data 975 involves the TCP/IP (Transmission Control Protocol/Internet Protocol) layer 971. Applications 200 and 230 use the UIIP 975 and TCP/IP 971 layers in communicating with manager 250 in commands 222, 224, 226, 233, 237, 247 and 255 as illustrated in FIG. 2. Manager 250 also communicates with applications 200 and 230 using HTTP 973 and TCP/IP 971 protocol as exemplified in command 257 of FIG. 2. Browser 10 and applications 200 and 230 communicate using TCP/IP 971 and HTTP 973 format URL data strings processed in accordance with the UIIP 975 as previously explained and indicated on FIG. 2.

FIG. 5 illustrates a system command flow diagram showing system protocol operation involving the web browser, a child application, a parent application, a managing application (e.g., GSM), and a CCOW context manager, in accordance with a preferred embodiment of the present invention. In the preferred embodiment, a set of GSM application program interfaces (APIs) supports an HL7 CCOW (Health Level 7 Clinical Content Object Workgroup) compliant common context. The additional abstraction layer combines the GSM session attributes and methods with additional context attributes and methods for implementing the preferred common context. The combination permits applications to run with or without the use of the common context based on the selection of GSM methods and attributes. Applications interact with the GSM API and the GSM 250 takes care of integrating the session and the common context. Preferably, the GSM 250 includes an HL7 CCOW standard compatible context manager component 236. The applications use the common context attributes and methods for interoperability with third party products. The applications interoperate without dependency on the common context.

Applications supporting the common context do additional processing to pay attention to the context when operating in a CCOW environment. The traditional parent-child style is supported for the application interoperability, whether running or not running in a CCOW environment.

A second GSM API set is created for applications supporting CCOW. The second GSM API set consists of the existing methods with some extensions (e.g., additional attributes and statuses), as well as some additional methods to support the common context.

Preferably, the system is implemented in software, but may also be implemented in hardware or as a combination of hardware and software. Various combinations of hardware and/or software, as well as various locations of the hardware and/or software may be employed to implement the present invention. For example, when the system is implemented in a hardware format or when viewed as a collection of conceptual elements, the system includes a data processor (also known as a communication processor or a transformation processor), a first interface processor, and a second interface processor. The data processor formats context data received from a first application to be compatible with an interface data format of a second application. The data processor formats the received context data to be compatible with an interface data format of a third application in response to examination of an indicator, preferably represented as a common context identification (ID), identifying a network connection to the third application. The first interface processor communicates formatted and compatible context data to the second application. The second interface processor communicates formatted and compatible context data to the third application. Preferably, the first, the second, and the third application correspond to the parent application 200, the GSM application 250, and the child application 230, respectively.

From a method point of view, the system supports concurrent operation of multiple network compatible applications using a corresponding plurality of different operation interfaces. The system receives context data from a first application. The system formats the received context data into a first format for communication to a first context manager (e.g., GSM 250). The system formats the received context data into a second format for communication to a second context manager (e.g., CCOW context manager 236). The system receives formatted context data for managing communication of context data to applications using a first command format interface type (e.g., compatible with the GSM 250). The system receives formatted context data for managing communication of context data to applications using a second command format interface type (e.g., compatible with the CCOW interface manager 236).

Preferably, the context data includes user identification information, an encryption key, a context identifier for identifying a single instance of application context, and/or a session identifier identifying a user initiated session and for use by a plurality of concurrently operating applications to uniquely identify the user initiated session. Preferably, the second application is a managing application, such as the GSM, supporting concurrent operation of a plurality of network compatible applications. Preferably, the third application is a Clinical Context Object Workgroup (CCOW) compatible application and the data processor formats the received context data to be compatible with a CCOW interface data format.

### GSM Methods—General Description

A set of methods works exclusively with the common context (these methods are prefixed with “CC” herein). Most of these additional methods are used by the parent application in order to establish and maintain participation in the common context when a session does not exist. Sessions are created and destroyed with a user logon and a user logoff respectively. The common context specific methods used by the child applications are those used to set and get data to/from the common context. Optionally, child applications may use the methods for suspending and resuming session participation in the common context.

### GSM Attributes—General Description

There are attributes of the present GSM methods. The methods may return additional information needed by the application to support the CCOW standard. Most notably are the notification strings that are used by the application as input to the notification applet/agent, and the context coupon indicating the revision number of the current context. Both of these elements are returned whenever the method call resulted in a change to the common context. There are other attributes as well that are further defined under the GSM Methods section.

### Additional GSM Events/Notifications—General Description

The GSM callback further includes the events generated by a CCOW common context, which are described in the GSM Events section.

### Implementation Requirements and Constraints

The UIIP/GSM is backward compatible with exiting UIIP applications. Applications using the existing GSM APIs and applications using the new GSM APIs are able to coexist within a single session without requiring any application changes.

An application uses one of the two API sets. Applications using the CCOW-enabled API set run in a non-CCOW configuration as well as in a CCOW configuration. An application determines if it is operating in a CCOW environment and operates accordingly.

Applications can run as CCOW enabled applications, if the parent application is CCOW enabled.

### Seven Primary Functions—General Description

1. A user references a parent application 200 URL.

2. The parent application 200 calls a GSM::CCCreateParticipantlnterface method to cause the GSM 250 to create a unique context participant interface. The parent application 200 then acquires the CCOW context handle from the desktop using an applet at the browser 10. The context handle is passed to the GSM 250 via a GSM::CCJoinCommonContext method. The GSM 250 joins the common context. The parent application 200 then uses a GSM::CCGetCommonContext method in an attempt to learn the user identity that may be established in the common context.

3. If the user ID was established in the common context, the parent application 200 starts a new session by calling a GSM::StartSession method. If the user ID was not established in the common context, then the parent application 200 goes through the process of having the user log on. Once the user is authenticated, the parent application then calls the GSM::StartSession method. Alternatively, the listener applet could have created a request to the parent application 200 in which case the parent application 200 would try to go through the process of acquiring the user ID from the common context and then starting the session.

4. At this point, the session is created and it is time to redirect to the child application 230. If the GSM::StartSession method actually caused a change in the CCOW context, then it would have returned the notification string used by the notification applet included in the redirect.

5. The child application 230 interacts with the GSM 250 for common context management.

6. The user selects the logoff function. The parent application 200 calls GSM::EndSession. The GSM 250 checks to see if the CCOW context change (e.g., nullifying the user subject) raises any messages from other applications. If so, the GSM 250 returns those messages to the application that called the GSM::StartSession. The application in turn gives the user the ability to cancel or commit to the logoff. If there where no messages raised or if the application calls the GSM::EndSession with the “override” set (i.e., a result of the user indicating he wishes to go ahead and commit the end-session), then the GSM 250 ends the session and nullifies the CCOW user subject.

7. If the GSM actually changed the CCOW context, then the notification string would be returned from the EndSession method, and the child application's redirect would need to include the notification applet. At this point, the parent application 200 URL is referenced again (e.g., via the redirect). However, the parent application 200 has already joined the common context so the creation of the participant interface and the acquiring of the CCOW context handle may be skipped.

### GSM Methods—Detailed Description

### CCCreateParticipantlnterface Method

Table 1 below illustrates command data, described as CCCreateParticipantlnterface, communicated from the parent application 200 to the managing application 250, in according with the preferred embodiment of the present invention. CCCreateParticipantlnterface is called to establish a common context participant Interface (used by and contained within the GSM) on behalf of the session. The output Participantlnterface is used as input to the common context locate method at the desktop. Preferably, the ParticipantInterface represents an indicator for identifying a communication interface format type of the first application (e.g., parent application). The output ContextID uniquely identifies a context. It is used as a key for methods related to the common context. It is also used in the StartSession method to associate the session with the already established common context. The output SMResult provides the result of the request as either a success (e.g., 1 or a failure (e.g., 0).

TABLE 1

| Name | In/Out | Type | Description |
|---|---|---|---|
| ParticipantInterface | Out | String | Common context participant |
| | | | interface used by GSM. |
| ContextID | Out | String | Context identifier. This is |
| | | | actually an index to the context |
| | | | interface instance created. |
| SMResult | Out | Integer | Result of request. |
| | | | Success |
| | | | Failure |

### CCDestroyParticipantlnterface Method

Table 2 below illustrates bi-directional command and response data, described as CCDestroyParticipantInterface, communicated between the parent application 200 and the GSM 250, in according with the preferred embodiment of the present invention. CCDestroyParticipantInterface is called to destroy the common context participant interface. This method is called after other GSM methods have been called before application termination. The input ContextID uniquely identifies a context. The output SMResult provides the result of the request as a success (e.g., 1), as a failure (e.g., 0), or as a not found (e.g., −1).

TABLE 2

| Name | In/Out | Type | Description |
|---|---|---|---|
| ContextID | In | String | Context identifier. |
| SMResult | Out | Integer | Result of request. |
| | | | Success |
| | | | Failure |
| | | | Not Found |

### CCJoinCommonContext Method

Table 3 below illustrates bidirectional command and response data, described as CCJoinCommonContext, communicated between the GSM 250 and the CCOW Context Manager 236, in according with the preferred embodiment of the present invention. CCJoinCommonContext is called to have the GSM establish participation in the common context indicated by the ContextID.

TABLE 3

| Name | In/Out | Type | Description |
|---|---|---|---|
| Context | In | String | Context handle to be used |
| | | | by the GSM for referencing |
| | | | a context manager. This |
| | | | parameter is mandatory |
| | | | when a common context is |
| | | | to be supported. |
| ContextID | In | String | Context identifier. |
| ApplicationName | In | String | Denotes a name to be as- |
| | | | signed to the overall |
| | | | session for use in the |
| | | | common context. |
| ContextKey | In | String or | Used as the shared key |
| | | Boolean | between the GSM and other |
| | | | common context compo- |
| | | | nents. (This is the |
| | | | shared secret key used |
| | | | to distribute public keys |
| | | | between CCOW com- |
| | | | ponents.) It may be a |
| | | | Boolean expression |
| | | | indicating that the |
| | | | application needs secured |
| | | | bindings (e.g., a CCOW |
| | | | secure application) or in |
| | | | another embodiment, may |
| | | | be the key itself. The |
| | | | private key (e.g., used |
| | | | for actual PKI) may |
| | | | be another item or |
| | | | the GSM may use one |
| | | | for the applications. |
| | | | This depends on how |
| | | | application, environment, |
| | | | and customer entities |
| | | | are partitioned with |
| | | | regard to CCOW context |
| | | | managers. |
| Suffix | In | String | Denotes the suffix to be |
| | | | used within the common |
| | | | context. This parameter is |
| | | | optional. |
| ContextUserMappings | In | Boolean | Indicates if the user |
| | | | mappings provided through |
| | | | common context manager |
| | | | are to be used to set |
| | | | the GSM user mappings. |
| ContextLogoff | In | Boolean | Indicates if a logoff should |
| | | | force a logoff of the |
| | | | applications in the |
| | | | common context. [Note |
| | | | this is not required by |
| | | | CCOW as long as the user |
| | | | has another mechanism to |
| | | | control this. An example |
| | | | of this might be to a |
| | | | context suspend before |
| | | | logging off.] |
| ShowLinkIcon | In | Boolean | Indicates if applications |
| | | | should display the link |
| | | | icon. |
| ContextSuspend | In | Integer | Indicates if applications |
| | | | should allow users to |
| | | | suspend the session from |
| | | | the common context. The |
| | | | value is enumerated as |
| | | | follows: |
| | | | 1. show link icon—allow |
| | | | suspend. |
| | | | 2. show link icon—disallow |
| | | | suspend. |
| | | | 3. do not show link icon— |
| | | | disallow suspend. |
| ParticipantCoupon | Out | String | Denotes the participant |
| | | | coupon assigned by the |
| | | | common context manager |
| | | | and used by the overall |
| | | | session. |
| ContextCoupon | Out | Integer | Indicates the current |
| | | | revision of the common |
| | | | context. |
| RegisterListenerInter- | Out | String | Interface to RegisterListen- |
| face | | | er method. This is used by |
| | | | listener applets. |
| SMResult | Out | Integer | Result of request. |
| | | | Success |
| | | | Failure |
| | | | Common Context Failure |
| | | | Not Found |

### CCGetCommomContext Method

Table 4 below illustrates bidirectional command and response data, described as GetCommonContext, communicated between the parent application 200 and the GSM 250, in according with the preferred embodiment of the present invention. GetCommonContext is called to learn the current state of the common context.

TABLE 4

| Name | In/Out | Type | Description |
|---|---|---|---|
| ContextID | In | String | Context identifier. |
| ContextCoupon | Out | Integer | Indicates the current revision |
| | | | of the common context. |
| ContextParticipation- | Out | Boolean | Indicates if the session is |
| Suspended | | | currently suspended from the |
| | | | common context. |
| ContextSubjectPrivi- | Out | String | Indicates the privilege levels |
| leges | | | assigned to the application for |
| | | | each common context subject |
| UserID | Out | String | UserID found in the common |
| | | | context user subject. |
| SMResult | Out | Integer | Result of request. |
| | | | Success |
| | | | Failure |
| | | | Not Found |

### CCLeaveCommonContext Method

Table 5 below illustrates bi-directional command and response data, described as CCLeaveCommonContext, communicated between the parent application 200 and the GSM 250, in according with the preferred embodiment of the present invention. CCLeaveCommonContext is called to end participation in the common context.

TABLE 5

| Name | In/Out | Type | Description |
|---|---|---|---|
| ContextID | In | String | Context identifier. |
| SMResult | Out | Integer | Result of request. |
| | | | Success |
| | | | Failure |
| | | | Not Found |

### CCSuspendParticipation Method

Table 6 below illustrates bi-directional command and response data, described as CCSuspendCommonContext, communicated between the parent application 200 and the GSM 250, in according with the preferred embodiment of the present invention. CCSuspendCommonContext suspends interaction with the common context manager. While suspended, the GSM session applications will not receive any Common Context-related events, nor will any references to the common context manager be carried out. The CCSsuspended event is sent to applications.

TABLE 6

| Name | In/Out | Type | Description |
|---|---|---|---|
| ContextID | In | String | Context identifier. |
| SMResult | Out | Integer | Result of request. |
| | | | Success |
| | | | Failure |
| | | | Not Found |

### CCResumeParticipation Method

Table 7 below illustrates bidirectional command and response data, described as CCResumeCommonContext, communicated between the parent application 200 and the GSM 250, in according with the preferred embodiment of the present invention. CCResumeCommonContext resumes interaction with the common context manager. The CCResume event is sent to applications.

TABLE 7

| Name | In/Out | Type | Description |
|---|---|---|---|
| ContextID | In | String | Context identifier. |
| SMResult | Out | Integer | Result of request. |
| | | | Success |
| | | | Failure |
| | | | Not Found |

### StartSession

Table 8 below illustrates bidirectional command and response data, described as StartSession, communicated between the parent application 200 and the GSM 250, in according with the preferred embodiment of the present invention. StartSession is called to establish a new session. Preferably, StartSession is called before generating links to another application. The caller of this method is responsible for valuing the session properties illustrated. Note that how these properties are valued (if at all) will affect the behavior of those applications that make use of them. None of these properties are mandatory.

When supporting use of a common context, the specified userID is checked against the appropriately mapped common context user subject to ensure that they match. If there is a mismatch, then a user mismatch error status is returned and the session is not created. If the common context user subject is not set, this method will set it.

In Table 8 and in Table 12, a session key preferably is used to encrypt and/or decrypt URL data. Preferably, the session key is conveyed in URL data. A session initiation request to the managing application preferably initiates generation of an encryption and/or decryption key particular to the user initiated session for use by the first application (e.g., parent application 200). Preferably, the encryption and/or decryption key is for common use by the multiple concurrently operating applications in encrypting data associated with a personal record. Preferably, an encryption key generator randomly generates an encryption key particular to the user-initiated session in response to the session initiation request.

In Tables 8, as well as Tables 9, 10, 11, 12, 13, 14, 15, 16, and 17, the GSM 250 preferably assigns a unique session identifier (Session ID).

TABLE 8

| | In/ | | |
|---|---|---|---|
| Name | Out | Type | Description |
| ContextID | In | String | Context identifier. Specifying this |
| | | | field indicates that the session is |
| | | | participating in a common context. |
| ContextCoupon | In | Integer | Indicates the context coupon the |
| | | | application thinks is current. An |
| | | | error is returned if this is not |
| | | | the same as the actual current |
| | | | context. |
| AuthServer | In | String | Authenticating service name. This |
| | | | identifies the authentication |
| | | | system (database) used to authenti- |
| | | | cate the user. It, along with |
| | | | UserID may be used as a key |
| | | | into a user-mapping tool for |
| | | | mapping userIDs (for a given |
| | | | user) across multiple systems. |
| | | | See appendix B for a description |
| | | | of how this field is to be |
| | | | constructed. |
| Language | In | String | Language and country identification. |
| | | | Preferably, the Internet RFC |
| | | | 1766 (i.e., a standard for language |
| | | | codes) is used. |
| LogoffURL | In | String | URL used to redirect the user to a |
| | | | log-on screen when a session time- |
| | | | out has been detected. The URL |
| | | | is fully qualified (i.e., no relative |
| | | | addressing). |
| LogoffURLTarget | In | String | Name of frame to be targeted when |
| | | | the browser is redirected to |
| | | | LogoffURL. |
| Timeout | In | Integer | Session time-out in seconds. If |
| | | | omitted, Timeout defaults to |
| | | | 10 minutes. |
| UserID | In | String | User Identification. This ID |
| | | | (along with the AuthServer |
| | | | property) is used to help |
| | | | identify the user. This ID |
| | | | should be the UserID used to |
| | | | authenticate the user. (See |
| | | | AuthServer). |
| SessID | Out | String | Unique Session Identifier assigned by |
| | | | the GSM. |
| SessionKey | Out | String | Key to be used to encrypt and decrypt |
| | | | URL data. |
| SMResult | Out | Integer | Result of request. |
| | | | Success |
| | | | Failure |
| | | | User Mismatch |
| | | | Invalid Context Coupon |
| | | | NoContinue |
| | | | NoCommonContext |
| | | | NoPrivilege |
| Notification | Out | String | Opaque string to be provided as input |
| | | | to the UI notification agent. |
| ContextChange- | Out | Integer | This value is set if the method caused |
| Coupon | | | a change to the common context. In |
| | | | this case, it indicates the new |
| | | | revision of the common context. |

### EndSession Method

Table 9 below illustrates bi-directional command and response data, described as EndSession, communicated between the parent application 200 and the GSM 250, in according with the preferred embodiment of the present invention. EndSession is called when a session is to be ended. Calling this method causes the session to be logically deleted and is most often used when a user signs off. A “Failure” result could be returned for a variety of reasons, but can safely be ignored when ending a session. A “Not Found” result indicates that the specified session does not exist. This error can also be safely ignored, but may indicate a problem with the application logic.

If the session has not been suspended from the common context, then the GSM will set the common context user subject to null. (Note the application will need to suspend the session from the COW context as part of logoff, and before calling this method if the attribute CCLogoff is set to false.)

If there are any conditional responses from other common context applications, they are returned in the Message attribute.

TABLE 9

| | In/ | | |
|---|---|---|---|
| Name | Out | Type | Description |
| SessID | In | String | Session Identifier. |
| Override | In | Boolean | Denotes that the session is to be |
| | | | ended without querying appli- |
| | | | cations. |
| SMResult | Out | Integer | Result of request. |
| | | | Success |
| | | | Failure |
| | | | Not Found |
| | | | NoContinue |
| Messages | Out | StringArray | Array of messages describing |
| | | | why a user might not want to |
| | | | change context. |
| Notification | Out | String | Opaque string to be provided as |
| | | | input to the UI notification |
| | | | agent. |
| ContextChange- | Out | Integer | This value is set if the |
| Coupon | | | method caused a change to the |
| | | | common context. In this case, it |
| | | | indicates the new revision of the |
| | | | common context. |

### RegisterUserMapping Method

Table 10 below illustrates bi-directional command and response data, described as RegisterUserMapping, communicated between the parent application 200 and the GSM 250, in according with the preferred embodiment of the present invention. RegisterUserMapping is called to add a user mapping to the session context. The mapping consists of a map name and its associated user identifier. The user mapping provided by this method is used by participant applications to determine the user identification. It is retrieved through the GetUserMapping method. A “Failure” result indicates that the service is unavailable. This may be due to a temporary condition (e.g. network problems) or to a permanent condition (e.g. a configuration error). A “Not Found” error indicates that the GSM has no record of the requested session ID. The calling application should display a message indicating that the session is no longer active and that the user should navigate to the logon screen to restart. A “Time Out” error indicates that the session has timed out. The application should redirect the browser to the URL found in the LogoffURL property targeted to the frame found in the LogoffURLTarget property from the GetSession method.

TABLE 10

| Name | In/Out | Type | Description |
|---|---|---|---|
| SessID | In | String | Session Identifier. |
| AuthServer | In | String | String used to identify the user |
| | | | database to which the UserID |
| | | | is associated. |
| UserID | In | String | The user identifier. |
| SMResult | Out | Integer | Result of request. |
| | | | Success |
| | | | Failure |
| | | | Not Found |
| | | | Time-out |
| Notification | Out | String | Opaque string to be provided as |
| | | | input to the UI notification agent. |
| ContextChange | Out | Integer | This value is set if the method caused |
| Coupon | | | a change to the common context. In |
| | | | this case, it indicates the new |
| | | | revision of the common context. |

### GetUserMapping Method

Table 11 below illustrates bidirectional command and response data, described as GetUserMapping, communicated between the child application 230 and the GSM 250, in according with the preferred embodiment of the present invention. GetUserMapping is called to retrieve the user identifier for a given authentication service or user database. The AuthServer is passed as input to indicate which user identifier is to be retrieved. A “Failure” result indicates that the service is unavailable. This may be due to a temporary condition (e.g. network problems) or to a permanent condition (e.g. a configuration error). A “Not Found” error indicates that the GSM has no record of the requested session ID. The calling application should display a message indicating that the session is no longer active and that he/she should navigate to the logon screen to restart. A “Time Out” error indicates that the session has timed out. The application should redirect the browser to the URL found in the LogoffURL property targeted to the frame found in the LogoffURLTarget property from the GetSession method.

TABLE 11

| Name | In/Out | Type | Description |
|---|---|---|---|
| SessID | In | String | Session Identifier. |
| AuthServer | In | String | String used to identify the user |
| | | | database to which the UserID is |
| | | | associated. |
| UserID | Out | String | The user identifier. |
| SMResult | Out | Integer | Result of request. |
| | | | Success |
| | | | Failure |
| | | | Not Found |
| | | | Time-out |
| Notification | Out | String | Opaque string to be provided as input |
| | | | to the UI notification agent. |
| ContextChange | Out | Integer | This value is set if the method |
| Coupon | | | caused a change to the common |
| | | | context. In this case, it indicates |
| | | | the new revision of the common |
| | | | context. |

### GetSession Method

Table 12 below illustrates bi-directional command and response data, described as GetSession, communicated between the child application 230 and the GSM 250, in according with the preferred embodiment of the present invention. GetSession is called to retrieve the session context maintained by the GSM 250. Preferably, the GSM 250 generates a session identifier particular to a user initiated session in response to receiving a session initiation request from a first application (e.g., parent application), and for communicating the session identifier to the first application (e.g., parent application) in a communication format determined in response to examining the indicator (e.g., ParticipantInterface from Table 1) identifying a communication interface format type of the first application (e.g., parent application).

A successful call to the GetSession method updates the session activity time stamp. A “Failure” result indicates that the service is unavailable. This may be due to a temporary condition (e.g. network problems) or to a permanent condition (e.g. a configuration error). A “Not Found” error indicates that the GSM has no record of the requested session ID. The calling application should display a message indicating that the session is no longer active and that he/she should navigate to the logon screen to restart. A “Time Out” error indicates that the session has timed out. In this case the properties LogoffURL and LogoffURLTarget and possibly the Notification and ContextChangeCoupon are still returned to the calling application. The other properties are not valued. The application should redirect the browser to the URL found in the LogoffURL property targeted to the frame found in the LogoffURLTarget property.

TABLE 12

| | In/ | | |
|---|---|---|---|
| Name | Out | Type | Description |
| SessID | In | String | Session Identifier. |
| AuthServer | Out | String | This identifies the authentication |
| | | | system (database) used to authenti- |
| | | | cate the user. (See appendix B for |
| | | | details.) |
| Language | Out | String | Language and country identifi- |
| | | | cation. The Internet RFC 1766 |
| | | | (standard for language codes) |
| | | | is to be used. |
| LogoffURL | Out | String | URL used to redirect the user to |
| | | | a log-on screen when a session |
| | | | time-out has been detected. The |
| | | | URL is fully qualified (no |
| | | | relative addressing). If blank, |
| | | | the application should return a |
| | | | blank page to the browser. |
| LogoffURLTarget | Out | String | Name of frame to be targeted |
| | | | when the browser is redirected to |
| | | | LogoffURL. If blank, no target |
| | | | frame should be specified. |
| Timeout | Out | Integer | Session time-out in seconds. |
| UserID | Out | String | User Identification used to |
| | | | authenticate the user. |
| SessionKey | Out | String | Key to be used to encrypt and |
| | | | decrypt URL data. |
| CommonContext- | Out | Boolean | Indicates if the session is |
| Support | | | supporting a common |
| | | | context. |
| ContextID | In | String | Context identifier. |
| RegisterListener- | Out | String | Interface to RegisterListener |
| Interface | | | method. This is used by listener |
| | | | applets. |
| ParticipantCoupon | Out | String | Denotes the participant coupon |
| | | | assigned by the common context |
| | | | manager and used by the overall |
| | | | session. |
| ContextCoupon | Out | Integer | Indicates the current revision of |
| | | | the common context. |
| ContextLogoff | Out | Boolean | Indicates if a logoff should force |
| | | | a logoff of the common context |
| | | | applications. |
| ContextSuspend | Out | Integer | Indicates if applications should |
| | | | allow users to suspend the session |
| | | | from the common context. The |
| | | | value is enumerated as follows: |
| | | | 1. show link icon—allow suspend |
| | | | 2. show link icon—disallow |
| | | | suspend |
| | | | 3. do not show link icon—disallow |
| | | | suspend |
| ContextSubject- | Out | String | Indicates the privilege levels |
| Privileges | | | assigned to the application for each |
| | | | common context subject. |
| ContextParticipa- | Out | Boolean | Indicates if the session is |
| tionSuspended | | | currently suspended from the |
| | | | common context. |
| SMResult | Out | Integer | Result of request. |
| | | | Success |
| | | | Failure |
| | | | Not Found |
| | | | Time-out |
| Notification | Out | String | Opaque string to be provided as |
| | | | input to the UI notification agent. |
| ContextChange- | Out | Integer | This value is set if the method |
| Coupon | | | caused a change to the common |
| | | | context. In this case, it |
| | | | indicates the new revision of |
| | | | the common context. |

### RegisterCallback Method

Table 13 below illustrates bi-directional command and response data, described as RegisterCallback, communicated between the parent application 200 or Child App 230 and the GSM 250, in according with the preferred embodiment of the present invention. RegisterCallback is called when an application wants to register a URL with the GSM to be called when an end-session event occurs. Calls to RegisterCallback update the session activity time stamp. A “Failure” result indicates that the service is unavailable. This may be due to a temporary condition (e.g. network problems) or to a permanent condition (e.g. a configuration error). A “Not Found” error indicates that the GSM has no record of the requested session ID. The calling application should display a message indicating that the session is no longer active and that he/she should navigate to the logon screen to restart. A “Time Out” error indicates that the session has timed out. The application should redirect the browser to the URL found in the LogoffURL property targeted to the frame found in the LogoffURLTarget property.

TABLE 13

| | In/ | | |
|---|---|---|---|
| Name | Out | Type | Description |
| SessID | In | String | Session Identifier |
| CallbackURL | In | String | URL to be contacted when a |
| | | | specified session event occurs. |
| | | | This can be any valid URL complete |
| | | | with path information and query |
| | | | data. The URL is referenced exactly |
| | | | as it is entered in this property. |
| | | | Preferably, the URL specified here |
| | | | is valid in the network segment where |
| | | | the GSM that invokes the callback |
| | | | operates (i.e., network address |
| | | | translation (NAT) should be |
| | | | considered). |
| CallbackType | In | Integer | Type of event that will trigger this |
| | | | callback. Possible values are |
| | | | End Session event |
| | | | Context changed survey |
| | | | Context changed event |
| | | | Context Suspend |
| | | | Context Resume |
| SMResult | Out | Integer | Result of request |
| | | | Success |
| | | | Failure |
| | | | Not Found |
| | | | Time-out |
| Notification | Out | String | Opaque string to be provided as |
| | | | input to the UI notification agent. |
| ContextChange- | Out | Integer | This value is set if the method |
| Coupon | | | caused a change to the common |
| | | | context. In this case, it indicates the |
| | | | new revision of the common context. |

### NotifySession Method

Table 14 below illustrates bi-directional command and response data, described as NotifySession, communicated between the child application 230 or parent application 200 and the GSM 250, in according with the preferred embodiment of the present invention. NotifySession is called whenever an application wants to update its activity status. Both the parent and the child application shall call it whenever an exchange with the user occurs. The GSM records the time it was notified. Calls to GetSession and RegisterCallback also update the session activity time stamp. A “Failure” result indicates that the service is unavailable. This may be due to a temporary condition (e.g. network problems) or to a permanent condition (e.g. a configuration error). A “Not Found” error indicates that the GSM has no record of the requested session ID. The calling application should display a message indicating that the session is no longer active and that he/she should navigate to the logon screen to restart. A “Time Out” error indicates that the session has timed out. The application should redirect the browser to the URL found in the LogoffURL property targeted to the frame found in the LogoffURLTarget property.

TABLE 14

| | In/ | | |
|---|---|---|---|
| Name | Out | Type | Description |
| SessID | In | String | Session Identification |
| SMResult | Out | Integer | Result of request |
| | | | Success |
| | | | Failure |
| | | | Not Found |
| | | | Time-out |
| Notification | Out | String | Opaque string to be provided as input |
| | | | to the UI notification agent. |
| ContextChange- | Out | Integer | This value is set if the method caused |
| Coupon | | | a change to the common context. In |
| | | | this case, it indicates the new revision |
| | | | of the common context. |

### GetSessionState Method

Table 15 below illustrates bi-directional command and response data, described as GetSessionState, communicated between the child application 230 or parent application 200 and the GSM 250, in according with the preferred embodiment of the present invention. GetSessionState is called to learn the current state of a session without changing the state. It returns the number of seconds since the last activity was recorded and the time-out threshold. Preferably, calls to GetSessionState do not update the session activity time stamp. A “Failure” result indicates that the service is unavailable. This may be due to a temporary condition (e.g. network problems) or to a permanent condition (e.g. a configuration error). A “Not Found” error indicates that the GSM has no record of the requested session ID. The calling application should display a message indicating that the session is no longer active and that he/she should navigate to the logon screen to restart. A “Time Out” error indicates that the session has timed out. The application should redirect the browser to the URL found in the LogoffURL property targeted to the frame found in the LogoffURLTarget property.

TABLE 15

| | In/ | | |
|---|---|---|---|
| Name | Out | Type | Description |
| SessID | In | String | Session Identifier |
| ActivityInterval | Out | Integer | Seconds since last activity. |
| Timeout | Out | Integer | Session time-out in seconds |
| ContextCoupon | Out | Integer | Indicates the current revision |
| | | | of the common context. |
| ContextParticipa- | Out | Boolean | Indicates if the session is currently |
| tionSuspended | | | suspended from the common context. |
| ContextSubject- | Out | String | Indicates the privilege levels assigned |
| Privileges | | | to the application for each common |
| | | | context subject. |
| SMResult | Out | Integer | Result of request |
| | | | Success |
| | | | Failure |
| | | | Not Found |
| | | | Time-out |
| Notification | Out | String | Opaque string to be provided as input |
| | | | to the UI notification agent. |
| ContextChange- | Out | Integer | Indicates the latest revision of the |
| Coupon | | | context. This value is incremented |
| | | | each time the context is changed. |

### CCSetCommonContextltems Method

Table 16 below illustrates bidirectional command and response data, described as SetCommonContextltems, communicated between the child application 230 or parent application 200 and the GSM 250, in according with the preferred embodiment of the present invention. SetCommonContextltems is called to set data into the common context and to delete common context items. Data names conform to the HL7 CCOW data naming conventions.

TABLE 16

| | In/ | | |
|---|---|---|---|
| Name | Out | Type | Description |
| SessID | In | String | Session Identifier. |
| DeleteItems | In | String | String indicating the names of |
| | | | the data items to be deleted. |
| SetItems | In | String | String indicating the names of |
| | | | the data items to be set along |
| | | | with their values. |
| Override | In | Boolean | Denotes that the data is to be set |
| | | | without querying applications. |
| ContextCoupon | In | Integer | Indicates the context coupon the |
| | | | application thinks is current. An |
| | | | error is returned if this is not |
| | | | the same as the actual current |
| | | | context. |
| SMResult | Out | Integer | Result of request. |
| | | | Success |
| | | | Failure |
| | | | Not Found |
| | | | Time-out |
| | | | Invalid Context Coupon |
| | | | NoContinue |
| | | | NoCommonContext |
| | | | ParticipationSuspended |
| Messages | Out | StringArray | Array of messages de- |
| | | | scribing why a user might not |
| | | | want to change context. |
| Notification | Out | String | Opaque string to be provided as |
| | | | input to the UI notification |
| | | | agent. |
| ContextChange- | Out | Integer | This value is set if the method |
| Coupon | | | caused a change to the common |
| | | | context. In this case, it indicates |
| | | | the new revision of the common |
| | | | context. |

### CCGetCommonContextltems Method

Table 17 below illustrates bi-directional command and response data, described as GetCommonContextltems, communicated between the child application 230 or the parent application 200 and the GSM 250, in according with the preferred embodiment of the present invention. GetCommonContextItems is called to get a list of the data element names and values from the common context. Data names conform to the HL7 CCOW data naming conventions. Subset of items can be requested.

TABLE 17

| | In/ | | |
|---|---|---|---|
| Name | Out | Type | Description |
| SessID | In | String | Session Identifier. |
| ItemsFilter | In | String | String indicating the names of |
| | | | the data item values to be |
| | | | fetched. |
| Items | In | String | String of requested data item |
| | | | name/value pairs. |
| SMResult | Out | Integer | Result of request. |
| | | | Success |
| | | | Failure |
| | | | Not Found |
| | | | Time-out |
| | | | NoCommonContext |
| | | | ParticipationSuspended |
| Messages | Out | StringArray | Array of messages describing |
| | | | why a user might not want to |
| | | | change context. |
| Notification | Out | String | Opaque string to be provided as |
| | | | input to the UI notification |
| | | | agent. |
| ContextChange- | Out | Integer | This value is set if the method |
| Coupon | | | caused a change to the common |
| | | | context. In this case, it indicates |
| | | | the new revision of the common |
| | | | context. |

### GSM Events

This section describes interactions for applications and the GSM for various events related to or initiated from the GSM. It is assumed that a common context is present.

### TimeOut Event

A timeout event occurs when an application references a session that has timed out. Note that it is not an actual asynchronous event but is triggered by an application referencing the GSM. In the event of a timeout, the GSM attempts to set the CCOW context user subject to null. If there are any conditional responses or busy applications, the CCOW context change transaction is cancelled and the inactivity timer of the session is reset. The calling application does not receive a timeout status. In effect, responses from other CCOW applications cancel the session timeout.

If there are no conditional survey responses from CCOW applications, then the CCOW context user subject is set to null, the CCOW context change transaction is committed, and the GSM proceeds with its timeout processing. That is, the GSM session is ended, the “end session” event notifications are delivered, and the “timeout” status (with notification string) is returned to the caller.

### EndSession Event

Applications that registered an EndSession callback will receive the EndSession event when the GSM ends a GSM session. The GSM will end a session either when a GSM application calls the EndSession method, when an application references a timed-out session, or when the CCOW User subject is set to null.

### CCContextChangedSurvey Event

A context-changed survey event occurs each time an application attempts to make a change in the common context. Any application that registered to be surveyed receives this event. The application responds with either an OK status or a text string to be displayed to the end user offering reasons on why the user may not want to change the context.

Parameters passed on in this event are:

A list of the common context subjects names being changed

### CCContextChanged Event

A context-changed event occurs each time the common context is changed. Any application that registered for the event receives notification.

Parameters passed on this event are:

A list of the common context subjects names that changed

A context coupon indicating the new revision number of the context.

### CCSuspendParticipation Event

A suspend event occurs whenever a UIIP application calls the CCSuspendParticipation method.

### CCResumeParticipation Event

A CC Resume event occurs whenever a UIIP application calls the CCResumeParticipation method.

Parameters passed on in this event are:

A context coupon indicating the new revision number of the context.

### CCOW Events

This section describes GSM processing of the CCOW generated events. CCOW generated events are not handled by applications directly.

### ContextChangesPending Event

A check is made to see if the GSM session associated with the CCOW context has callbacks registered for a context change survey. If so, the appropriate callbacks are invoked and the proper survey status and text messages are returned to the CCOW context manager.

### ContextChangesAccepted Event

If the CCOW user subject has changed, then the GSM session is ended and the “end session” notification messages are sent to the appropriate session applications. If some other data item changes, the GSM “context changed” notification event is sent to the appropriate applications.

### ContextChangesCanceled Event

Context cancellations do not affect the GSM or session applications.

### CommonContextTerminated Event

This event is treated as a non-recoverable error. The GSM ends the GSM session, removes references to the CCOW context, and sends the “end session” notification message to the appropriate applications

### Ping Event

The GSM answers the ping if a common context interface exists for the specified context.

In summary of the preferred embodiment of the present invention, an adaptive system supports the use of different application interoperability methods and operational interfaces supporting concurrent use of different network (including the Internet) compatible applications.

The architectures and processes presented in FIGS. 2, 3, 4, and 5 are not exclusive and the data formats of Tables 1-17 are adaptable to accommodate different elements and properties. Other architectures and processes may also be derived in accordance with the principles of the invention to accomplish the same objectives. Further, the communication processes and steps of FIGS. 2 and 5 and data formats of Tables 1-17 may be implemented on different platforms for different functions and may be applied within the applications internal to a processing device such as a personal computer (PC) or other processing device or system. The communication processes of FIGS. 2 and 5 and data formats of Tables 1-17 may also be applied for Internet or intranet (or any other type of network) based work flow or task implementation. The inventive principles may be employed in any system involving the concurrent operation of different applications.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

1. A system supporting concurrent operation of a plurality of network compatible applications using a corresponding plurality of different operation interfaces, comprising:
a data processor for formatting context data received from a first application to be compatible with an interface data format of a second application and for formatting said received context data to be compatible with an interface data format of third application in response to examination of an indicator identifying a network connection to said third application;
a first interface processor for communicating formatted and compatible context data to said second application; and
a second interface processor for communicating formatted and compatible context data to said third application.

2. A system according to claim 1, wherein said context data comprises at least one of:
(a) user identification information,
(b) an encryption key, and
(c) a session identifier identifying a user initiated session and for use by a plurality of concurrently operating applications to uniquely identify the user initiated session.

3. A system according to claim 1, wherein said third application is a Clinical Context Object Workgroup (CCOW) compatible application and said data processor formats said received context data to be compatible with a CCOW interface data format.

4. A system according to claim 1, wherein said second application is a managing application supporting concurrent operation of a plurality of network compatible applications.

5. A method for supporting concurrent operation of a plurality of network compatible applications using a corresponding plurality of different operation interfaces, the method comprising the steps of:
receiving context data from a first application;
formatting received context data into a first format for communication to a first context manager;
formatting received context data into a second format for communication to a second context manager;
receiving formatted context data for managing communication of context data to applications using a first command format interface type; and
receiving formatted context data for managing communication of context data to applications using a second command format interface type.

6. A method according to claim 5, wherein said second command interface type is compatible with a Clinical Context Object Workgroup (CCOW) application interface standard and is different from said first command format interface type.

7. A method according to claim 5, wherein said context data comprises at least one of:
(a) user identification information,
(b) a context identifier for identifying a single instance of application context,
(c) an encryption key, and
(d) a session identifier identifying a user initiated session and for use by a plurality of concurrently operating applications to uniquely identify the user initiated session.

8. A method according to claim 7, wherein
said context identifier in said first command format interface type identifies a single operating instance of a CCOW compatible application context, and
said session identifier in said second command format interface type identifies a single user initiated operating session involving concurrent operation of said plurality of concurrently operating applications.

9. A system supporting concurrent operation of a plurality of Internet compatible applications, the system comprising:
a browser application providing a user interface display permitting user entry of identification information and commands for a plurality of Internet compatible applications and for providing user identification information to a first application for validation; and
a managing application for generating a session identifier particular to a user initiated session in response to receiving a session initiation request from a first application and for communicating said session identifier to said first application in a communication format determined in response to examining an indicator identifying a communication interface format type of said first application.

10. A system according to claim 9, wherein said session initiation request to said managing application also initiates generation of an encryption key particular to said user initiated session for use by said first application.

11. A system according to claim 10, wherein said encryption key is for common use by said plurality of concurrently operating applications in encrypting data associated with a personal record.

12. A system according to claim 9, wherein said managing application also communicates additional parameters to said first application including one or more of:
(a) a key to be used in encrypting and decrypting a session identifier conveyed in URL data, and
(b) an indicator identifying whether or not a session initiation request is successful.

13. A system employed by a managing application for supporting concurrent operation of a plurality of network compatible applications, the system comprising:
an input processor for receiving from a first application a session initiation request to initiate generation of a session identifier;
a session identifier generator for generating a session identifier particular to a user initiated session and for use by a plurality of concurrently operating applications to uniquely identify said user initiated session; and
a communication processor for
communicating said session identifier to said first application in a first communication format; and
communicating said session identifier to an other application of said plurality of concurrently operating applications in a second communication format determined in response to a request to receive said generated session identifier.

14. A system according to claim 13, wherein said communication processor communicates said session identifier to said other application in response to examining an indicator identifying a communication interface format type of said other application.

15. A system according to claim 13 further comprising:
an encryption key generator for substantially randomly generating an encryption key particular to said user initiated session in response to said session initiation request.

16. A system according to claim 13, wherein said communication processor includes said generated session identifier in different types of command messages communicated to applications of said plurality of concurrently operating applications.

17. A system supporting concurrent operation of a plurality of network compatible applications using a corresponding plurality of different operation interfaces, the system comprising:
a transformation processor for receiving context data from a first application and for formatting received context data into a first format for communication to a first context manager and for formatting received context data into a second format for communication to a second context manager;
a first context manager receiving formatted context data from said transformation processor for managing communication of context data to applications using a first command format interface type; and
a second context manager receiving formatted context data from said transformation processor for managing communication of context data to applications using a second command format interface type.

18. A method for supporting concurrent operation of a plurality of network compatible applications using a corresponding plurality of different operation interfaces, comprising the steps of:
formatting context data received from a first application to be compatible with an interface data format of a second application;
formatting said received context data to be compatible with an interface data format of third application in response to examination of an indicator identifying a network connection to said third application;
communicating formatted and compatible context data to said second application; and
communicating formatted and compatible context data to said third application.

19. A method employed by a managing application for supporting concurrent operation of a plurality of network compatible applications, comprising the steps of:
receiving from a first application a session initiation request to initiate generation of a session identifier;
generating a session identifier for user initiated session and for use by a plurality of concurrently operating applications to uniquely identify said user initiated session;
communicating said session identifier to said first application in a first communication format; and
communicating said session identifier to an other application of said plurality of concurrently operating applications in a second communication format determined in response to a request to receive said generated session identifier.
